(19) United States
(12) Patent Application Publication
(10) Pub. No.: US 2007/0212013 A1
(43) Pub. Date: Sep. 13, 2007

(54) Photocurable Resin Composition for Forming Optical Waveguide, Photocurable Dry Film for Forming Optical Waveguide, and Optical Waveguide

(75) Inventors: Daisuke Kojima, Kanagawa (JP); Higuchi Takahiro, Kanagawa (JP); Imai Genji, Kanagawa (JP)

Correspondence Address: KRATZ, QUINTOS & HANSON, LLP, 1420 K Street, N.W., Suite 400, WASHINGTON, DC, 20005, US

(73) Assignee: KANSAI PAINT CO., LTD, Amagasaki-shi (JP)

(21) Appl. No.: 10/588,796

(22) PCT Filed: Feb. 25, 2005
(86) PCT No.: PCT/JP05/03214

§ 371 Date: Aug. 9, 2006

(30) Foreign Application Priority Data
Feb. 25, 2004 (JP) 2004-049827

(51) Int. Cl. G02B 6/12; C08F 299/00

(52) U.S. Cl. 385/145; 522/178

(57) ABSTRACT

Disclosed is a photocurable resin composition and photocurable dry film that are very useful for forming optical waveguides. The present invention provides a photocurable resin composition for forming an optical waveguide, comprising a carboxy-containing unsaturated resin (A) obtained by reacting a carboxy-containing resin (a) with an epoxy-containing unsaturated compound (b); and a solvent (B); and an optical waveguide-forming photocurable dry film formed using the resin composition.

### TECHNICAL FIELD

The present invention relates to a photocurable resin composition for forming an optical waveguide, a photocurable dry film for forming an optical waveguide and an optical waveguide.

### BACKGROUND ART

In recent years, optical waveguides have been attracting attention as optical transmission media that meet the demand for increased capacity and speed of information processing in optical communication systems, computers, etc.

Quartz waveguides are representative optical waveguides, but have problems in that they require special production facilities, long production times, etc.

As substitutes for such quartz waveguides, organic polymer optical waveguides which are free from the above problems have been developed.

JP 2003-149475 A discloses a resin composition for forming an optical waveguide, comprising an ethylenically unsaturated group-containing carboxylic acid resin having at least one ethylenically unsaturated group and at least one carboxy group per molecule; a diluent; and a photopolymerization initiator.

However, the composition has a problem in that the production process for the ethylenically unsaturated group-containing carboxylic acid resin is complicated. Specifically, the resin is produced by a complicated process in which an epoxy resin having at least two epoxy groups per molecule, (meth)acrylic acid, and optionally a compound having one carboxy group and two hydroxy groups per molecule are reacted, and then the reaction product is further reacted with a polybasic acid anhydride. Further, in some cases, unsaturated groups and/or carboxy groups are not sufficiently introduced into the resin.

Furthermore, the above optical waveguide-forming resin composition has a drawback in that films formed using the composition have poor processability, poor mechanical properties, etc. Therefore, it is difficult to use the composition as a dry film.

### DISCLOSURE OF INVENTION

Problems to be Solved by the Invention

An object of the present invention is to provide a photocurable resin composition and photocurable dry film that can form film layers having excellent processability, excellent mechanical properties; etc., and that are very useful for forming optical waveguides; and an optical waveguide obtained using the resin composition and/or the dry film.

Means for Solving the Problems

The present invention provides the following optical waveguide-forming photocurable resin composition, optical waveguide-forming photocurable dry film, and optical waveguide.

1. A photocurable resin composition for forming an optical waveguide, the composition comprising a carboxy-containing unsaturated resin (A) obtained by reacting a carboxy-containing resin (a) with an epoxy-containing unsaturated compound (b); and a solvent (B).

2. The photocurable resin composition according to item 1, further comprising a radical photopolymerization initiator.

3. A photocurable dry film for forming an optical waveguide, which is formed using the photocurable resin composition according to item 1.

4. An optical waveguide comprising a lower cladding layer (I), a core (II) and an upper cladding layer (III), wherein at least one of (I), (II) and (III) is formed using the photocurable resin composition according to item 1.

5. An optical waveguide comprising a lower cladding layer (I), a core (II) and an upper cladding layer (III), wherein at least one of (I), (II) and (III) is formed using the photocurable dry film according to item 3.

The present invention is described below in detail.

The optical waveguide-forming photocurable resin composition of the present invention comprises a carboxy-containing unsaturated resin (A) obtained by reacting a carboxy-containing resin (a) with an epoxy-containing unsaturated compound (b); and a solvent (B).

Carboxy-Containing Resin (a)

The carboxy-containing resin (a) is a resin having an average of at least two, and preferably an average of at least three, carboxy groups per molecule. When the average number of carboxy groups per molecule is less than two, only a small amount of carboxy groups remain in the resin after consumption by the reaction with the epoxy-containing unsaturated compound (b). As a result, when the photocurable resin composition is irradiated with light, only a small difference in alkaline developer solubility is produced between the irradiated and unirradiated portions, and thus the boundary of the irradiated and unirradiated portions may become unclear, possibly failing to form a sharply defined core.

The carboxy-containing resin (a) preferably has a number average molecular weight of 1000 to 100000, and more preferably 2000 to 80000. When the number average molecular weight is less than 1000, dry films formed using the photocurable resin composition may have poor processability and/or poor winding ability. Further, when the photocurable resin composition is irradiated with light, only a small difference in alkaline developer solubility is produced between the irradiated and unirradiated portions, and thus the boundary between the irradiated and unirradiated portions may be unclear, possibly failing to form a sharply defined core.

Known carboxy-containing resins can be used as the carboxy-containing resin (a) without limitation. Examples of usable resins include acrylic resins (including vinyl resins), carboxy-containing fluororesins, polyester resins, silicon resins, alkyd resins, modified resins comprising two or more of these, mixtures of two or more of these, etc. Among these resins, acrylic resins and carboxy-containing fluororesins are preferable.

Acrylic Resin

Examples of usable acrylic resins include those obtained by copolymerizing an α,β-ethylenically unsaturated acid such as acrylic acid, methacrylic acid or the like as an essential monomer component, with at least one unsaturated monomer selected from methyl (meth)acrylate, ethyl (meth)acrylate, propyl (meth)acrylate, butyl (meth)acrylate, 2-ethylhexyl (meth)acrylate, hydroxyethyl (meth)acrylate and like (meth)acrylates, styrene, (meth)acrylonitrile, (meth)acrylamide, etc.

Carboxy-Containing Fluororesin

Usable carboxy-containing fluororesins include those obtained by copolymerizing α,β-ethylenically unsaturated acids, such as acrylic acid, methacrylic acid, maleic anhydride, maleic acid, itaconic acid, etc. as essential monomer components, with monomers each having a perfluoroalkyl group or perfluoroalkenyl group at one end and an ethylenic double bond at the other end (preferably perfluorobutylethyl methacrylate, perfluorooctylethyl methacrylate, perfluoroisononylethyl methacrylate or perfluorodecylethyl methacrylate), and optionally an unsaturated monomer as mentioned above.

Also usable are carboxy-containing fluororesins obtained by copolymerizing fluoroolefins, hydroxy-containing radically polymerizable unsaturated monomers, and optionally other radically polymerizable unsaturated monomers, such as α-olefins, vinyl ethers, fatty acid vinyl esters, fatty acid isopropenyl esters, etc., to prepare hydroxy-containing fluororesins, which are then subjected to addition reaction with polybasic acid anhydrides (e.g., itaconic anhydride, succinic anhydride, etc.) to introduce carboxy groups. Examples of fluoroolefins include vinyl fluoride, vinylidene fluoride, ethylene chloride trifluoride, ethylene tetrafluoride, etc. Examples of hydroxy-containing radically polymerizable unsaturated monomers include hydroxyethyl vinyl ether, hydroxypropyl vinyl ether, hydroxybutyl vinyl ether, hydroxypentyl vinyl ether and like hydroxyalkyl vinyl ethers, ethylene glycol monoallyl ether, diethylene glycol monoallyl ether, triethylene glycol monoallyl ether and like hydroxyallyl ether, etc. Examples of α-olefins include ethylene, propylene, isobutylene, butylene-1, etc. Examples of vinyl ethers include ethyl vinyl ether, isobutyl vinyl ether, butyl vinyl ether, cyclohexyl vinyl ether, etc. Examples of fatty acid vinyl esters include vinyl acetate, vinyl lactate, vinyl butyrate, vinyl isobutyrate, vinyl caproate, vinyl pivalate, vinyl caprylate, etc. Examples of fatty acid isopropenyl esters include isopropenyl acetate, isopropenyl propionate, etc.

Epoxy-Containing Unsaturated Compound (b)

The epoxy-containing unsaturated compound (b) has an average of at least one epoxy group and an average of one unsaturated group per molecule. Examples of such compounds include glycidyl (meth)acrylate, allyl glycidyl ether, vinylcyclohexene monoxide, 3,4-epoxycyclohexylmethyl (meth)acrylate, etc.

Also usable are compounds obtained by reacting α,β-ethylenically unsaturated acids with part of epoxy groups in epoxy resins such as bisphenol epichlorohydrin-type epoxy resins, novolac epoxy resins, alicyclic polyepoxides, (co)polymers of epoxy-containing unsaturated compounds as mentioned above, etc.

Carboxy-Containing Unsaturated Resin (A)

The carboxy-containing unsaturated resin (A) for use in the present invention can be easily produced by reacting a mixture of the carboxy-containing resin (a) with the epoxy-containing unsaturated compound (b), for example, in the presence of tetraethylammonium bromide or like catalyst at 80 to 120° C. for 1 to 5 hours.

The optical waveguide-forming photocurable resin composition of the present invention contains the carboxy-containing unsaturated resin (A), and when the composition is irradiated with light, it is cured by polymerization and crosslinking of unsaturated groups in the resin. Examples of light that can be used for irradiation include electron rays, ultraviolet rays, visible rays and like active energy rays. When irradiation with ultraviolet rays or visible rays is performed to effect crosslinking, radical photopolymerization initiators and optionally photosensitizers (photosensitizing dyes) can be added.

Known radical photopolymerization initiators can be used, including, for example, benzophenone, benzoin methyl ether, benzoin isopropyl ether, benzylxanthone, thioxanthone, anthraquinone and like aromatic carbonyl compounds; acetophenone, propiophenone, α-hydroxyisobutylphenone, α,α′-dichloro-4-phenoxyacetophenone, 1-hydroxy-1-cyclohexylacetophenone, diacetylacetophenone, acetophenone and like acetophenone compounds; benzoyl peroxide, t-butylperoxy-2-ethylhexanoate, t-butylhydroperoxide, di-t-butyldiperoxyisophthalate, 3,3′,4,4′-tetra(t-butylperoxycarbonyl)benzophenone and like organic peroxides; diphenyliodonium bromide, diphenyliodonium chloride and like diphenylhalonium salts; carbon tetrabromide, chloroform, iodoform and like organic halides; 3-phenyl-5-isoxazoline, 2,4,6-tris(trichloromethyl)-1,3,5-triazine benzanthrone and like heterocyclic and polycyclic compounds; 2,2′-azo(2,4-dimethylvaleronitrile), 2,2-azobisisobutyronitril, 1,1′-azobis(cyclohexane-1-carbonitrile), 2,2′-azobis(2-methylbutyronitrile) and like azo compounds; iron-allene complexes (see European Patent No. 152377); titanocene compounds (see JP 63-221110 A); bisimidazole compounds; N-aryl glycidyl compounds; acridine compounds; combinations of aromatic ketones and aromatic amines; peroxyketals (see JP 6-321895 A), etc.

Among these radical photopolymerization initiators, di-t-butyldiperoxyisophthalate, 3,3′,4,4′-tetra(t-butylperoxycarbonyl)benzophenone, iron-allene complexes and titanocene compound are preferable, since they have high activity for crosslinking or polymerization.

Commercial radical photopolymerization initiators are usable, including, for example, “Irgacure 651” (a tradename of Ciba Speciality Chemicals; an acetophenone radical photopolymerization initiator), “Irgacure 184” (a tradename of Ciba Speciality Chemicals; an acetophenone radical photopolymerization initiator), “Irgacure 1850” (a tradename of Ciba Speciality Chemicals; an acetophenone radical photopolymerization initiator), “Irgacure 907” (a tradename of Ciba Speciality Chemicals; an aminoalkylphenone radical photopolymerization initiator), “Irgacure 369” (a tradename of Ciba Speciality Chemicals; an aminoalkylphenone radical photopolymerization initiator), “Lucirin TPO” (a tradename of BASF A.G.; 2,4,6-trimethylbenzoyldiphenylphosphine oxide), “Kayacure DETXS” (a tradename of Nippon Kayaku Co., Ltd.), “CGI-784” (a tradename of Ciba Speciality Chemicals; a titanium complex compound), etc.

Such radical photopolymerization initiators can be used singly or in combination.

When a radical photopolymerization initiator is used in the photocurable resin composition of the present invention, the proportion thereof is preferably about 0.5 to about 10 parts by weight per 100 parts by weight of the carboxy-containing unsaturated resin (A).

Examples of photosensitizing dyes include thioxanthene dyes, xanthene dyes, ketone dyes, thiopyrylium salt dyes, bisstyryl dyes, merocyanine dyes, 3-substituted coumarin dyes, 3,4-substituted coumarin dyes, cyanine-dyes, acridine dyes, thiazine dyes, phenothiazine dyes, anthracene dyes, coronene dyes, benzanthracene dyes, perylene dyes, merocyanine dyes, ketocoumarin dyes, fumarine dyes, borate dyes, etc. Such dyes can be used singly or in combination. Examples of borate photosensitizing dyes include those mentioned in JP 5-241338 A, JP 7-5685 A and JP 7-225474 A.

The photocurable resin composition of the present invention may contain, where necessary, a curing agent for crosslinking carboxy groups in the carboxy-containing unsaturated resin (A), such as a polyepoxide.

Examples of usable polyepoxides include bisphenol-type epoxy resins obtained by reacting bisphenol compounds with haloepoxides such as epichlorohydrin, β-methylepichlorohydrin, etc.; halogenated bisphenol-type epoxy resins; phosphorus-modified bisphenol-type epoxy resins obtained by chemical reaction with phosphorus compounds; alicyclic epoxy resins obtained by hydrogenating bisphenol-type epoxy resins; novolac-type epoxy resins obtained by reacting haloepoxides with phenol novolac resins, cresol novolac resins, etc; glycidyl ester-type epoxy resins obtained by reacting epichlorohydrin with polybasic acids such as phthalic acid, dimer acid, etc.; glycidyl amine-type epoxy resins obtained by reacting epichlorohydrin with polyamines such as diaminodiphenylmethane, isocyanuric acid, etc.; linear aliphatic epoxy resins and alicyclic epoxy resins obtained by oxidizing olefin bonds with peracids such as peracetic acid; biphenyl-type epoxy resins obtained by reacting biphenols with epichlorohydrin; etc.

Among such polyepoxides, bisphenol-type epoxy resins, novolac-type epoxy resins, etc., can be preferably used since they are highly effective for improving heat resistance, which is required of optical waveguides.

When forming a lower cladding layer of an optical waveguide using a photocurable resin composition of the present invention containing a curing agent, the lower cladding layer can, for example, be heated after photocuring, to cause a reaction of the curing agent with carboxy groups derived from the carboxy-containing unsaturated resin (A), thereby making the lower cladding layer firmer. Similarly, when forming a core or upper cladding layer using such a composition, the core or upper cladding layer can, for example, be heated after photocuring, to cause a reaction of the curing agent with carboxy groups derived from the carboxy-containing unsaturated resin (A), thereby making the core and upper cladding layer firmer.

The heat-curing may be performed after formation of each layer, or two or three layers may be first formed and then simultaneously heat-cured.

The proportion of curing agent such as a polyepoxide is preferably selected so that the amount of epoxy groups is 0.1 to 1.5 mol, and more preferably 0.5 to 1.1 mol, per mol of carboxy groups.

Use of a curing agent in an amount such that no carboxy groups remain in the heat-cured layers (in particular the upper cladding layer) improves the water resistance, heat resistance, moisture resistance and other properties of the resulting optical waveguide.

The photocurable resin composition of the present invention may contain, when necessary, unsaturated compounds other than those mentioned above; adhesion promoters; hydroquinone, 2,6-di-t-butyl-p-cresol, N,N-diphenyl-p-phenylenediamine and like polymerization inhibitors; fine particles of organic resins such as saturated resins, unsaturated resins, (unsaturated group-containing) vinyl polymers, etc.; coloring pigments, extender pigments and like pigments; cobalt oxide and like metal oxides; dibutyl phthalate, dioctyl phthalate, tricresyl phosphate, polyethylene glycol, polypropylene glycol and like plasticizers; anticissing agents; fluidity controlling agents; etc.

Usable unsaturated compounds include, for example, monomers, dimers, trimers and other oligomers that preferably have 1 to 4 radically polymerizable unsaturated groups and that, when exposed to light, undergo addition polymerization to render the exposed portion insoluble. Examples of unsaturated compounds include, in addition to the monomers mentioned above, such as (meth)acrylates, styrene, etc., ethylene glycol di(meth)acrylate, diethylene glycol di(meth)acrylate, triethylene glycol di(meth)acrylate, di(meth)acrylates of tetraethylene glycol and higher poly(penta to hexadeca)ethylene glycol, propylene glycol di(meth)acrylate, trimethylolpropane tri(meth)acrylate, pentaerythritol tetra(meth)acrylate, ethylene glycol diitaconate, ethylene glycol dimaleate, hydroquinone di(meth)acrylate, resorcinol di(meth)acrylate, pyrogallol (meth)acrylate, oligourethane acrylate, oligoepoxy acrylate, divinylbenzene and like polyfunctional unsaturated compounds having at least two unsaturated groups. Such unsaturated compounds can be used singly or in combination.

The amount of unsaturated compound to be used is preferably not more than 200 parts by weight, and more preferably 3 to 100 parts by weight, per 100 parts by weight of the carboxy-containing unsaturated resin (A).

Saturated resins can be used to suppress the solubility of the film of the photocurable resin composition in, for example, alkaline developers or the like. Examples of saturated resins include polyester resins, alkyd resins, (meth)acrylic resins, vinyl resins, epoxy resins, phenol resins, natural resin, synthetic rubbers, silicon resins, fluororesins, polyurethane resins, etc. Such resins can be used singly or in combination.

Examples of unsaturated resins include the same resins as mentioned above as saturated resins except that unsaturated resins have an average of about 1 to about 10, and more preferably an average of about 1 to about 4, unsaturated groups per molecule.

The amount of saturated resin and/or unsaturated resin to be used is preferably not more than 200 parts by weight, and more preferably 3 to 100 parts by weight, per 100 parts by weight of the carboxy-containing unsaturated resin (A).

The photocurable resin composition of the present invention may further contain, for example, fillers, coloring agents, leveling agents, heat-resistant stabilizers, discoloration preventing agents, antioxidants, mold releasing agents, surface treating agents, flame retardants, viscosity modifiers, plasticizers, antimicrobial agents, mildew-proofing agents, antifoaming agents, coupling agents, etc., as required.

The photocurable resin composition of the present invention is prepared by dissolving or dispersing the carboxy-containing unsaturated resin (A), optionally together with a radical photopolymerization initiator and/or the like, in the solvent (B), which is an organic solvent, water or the like.

The amount of solvent (B) is preferably about 30 to about 2000 parts by weight per 100 parts by weight of the carboxy-containing unsaturated resin (A).

The resin-composition of the present invention in the form of an organic solvent-based liquid is obtained by dissolving or dispersing the carboxy-containing unsaturated resin (A) and optional components in an organic solvent, such as a ketone, ester, ether, cellosolve, aromatic hydrocarbon, alcohol, halogenated hydrocarbon or the like. A film for forming an optical waveguide can be obtained by applying the composition on an optical waveguide substrate by roller coating, roll coating, spin coating, curtain roll coating, spray coating, electrostatic coating, dip coating, silk printing or like method, setting the applied composition as required, and then performing drying.

The resin composition of the present invention in the form of an aqueous liquid can be obtained by dissolving or dispersing the carboxy-containing unsaturated resin (A) and optional components in water or a mixture of water and organic solvent. The carboxy-containing unsaturated resin (A) is made soluble or dispersible in water by neutralizing carboxy groups in the resin (A) with a neutralizer (alkali).

Examples of neutralizers include monoethanolamine, diethanolamine, triethylamine, diethylamine, dimethylaminoethanol, cyclohexylamine, ammonia, etc. The amount of neutralizer to be used is preferably 0.2 to 1.0 equivalent, and more preferably 0.3 to 0.8 equivalents, per equivalent of carboxy groups.

The optical waveguide-forming curable dry film of the present invention can be obtained by, for example, applying the resin composition in the form of an organic solvent-based or aqueous liquid on a base film, using a roll coater, blade coater, curtain flow coater or the like, followed by drying. The dry film preferably has a thickness of about 1 μm to about 2 mm, and more preferably about 1 μm to about 1 mm.

Usable base films include, for example, films of polyethylene terephthalate, aramid, Kapton, polymethylpentene, polyethylene, polypropylene, etc., among which polyethylene terephthalate films are preferable to achieve low cost and good properties of the dry film. The base film preferably has a thickness of 1 μm to 10 mm, and more preferably 10 μm to 1 mm.

After or without peeling off the base film, the dry film is cured as required, by exposure to light such as, for example, visible rays, for forming an optical waveguide. Then, the base film is peeled off when it has not been peeled off. The dry film thus obtained can be used for forming an optical waveguide. The dry film can be developed to form a core. The dry film may be provided with a cover coat layer, where necessary. The cover coat layer can be formed on the dry film by coating or bonding.

The curable dry film of the present invention preferably has a softening temperature within the range of 0° C. to 200° C., and more preferably within the range of 10° C to 150° C. When the dry film has a softening temperature lower than 0° C., the dry film is softened and becomes sticky when heated for bonding to a substrate, possibly making bonding operation extremely difficult and/or forming bubbles after bonding. When the dry film has a softening temperature higher than 200° C., bonding may be difficult.

As used herein, the softening temperature is determined from thermal deformation behavior of a 1 mm-thick sheet, using a thermomechanical analyzer. Specifically, a load of 49 g is applied to a quartz needle placed on the sheet; the sheet is heated at a rate of 5° C./min; and the temperature at which the needle penetrates into the sheet to a depth of 0.635 mm is defined as the softening temperature. Examples of usable thermomechanical analyzers include those commercially available from Du Pont.

Light sources usable for photocuring include, for example, extra-high-pressure, high-pressure, medium-pressure, low-pressure mercury lamps, chemical lamps, carbon arc lamps, xenon lamps, metal halide lamps, tungsten lamps, etc. Various lasers having oscillation lines in the ultraviolet or visible region can also be used. Examples of preferable lasers include argon lasers having oscillation lines at 355 nm, YAG-THG lasers having oscillation lines at 355 nm, semiconductor (InGaN) lasers having oscillation lines at 405 nm, argon lasers having oscillation lines at 488 nm, YAG-SHG lasers having oscillation lines at 532 nm, etc.

The optical waveguide of the present invention comprises a lower cladding layer (I), a core (II) and an upper cladding layer (III), and at least one of (I), (II) and (III) is formed using the optical waveguide-forming photocurable resin composition or optical waveguide-forming photocurable dry film described above.

In the optical waveguide of the present invention, all of the lower cladding layer (I), core (II) and upper cladding layer (III) may be formed using the curable resin composition of the present invention, or all of these components (I), (II) and (III) may be formed using the curable dry film of the present invention. The optical waveguide of the present invention may also be formed by combined use of the photocurable resin composition and photocurable dry film. It is also possible to use known compositions and/or dry films as part of the optical waveguide.

The lower cladding layer (I), core (II) and upper cladding layer (III) are described below.

Lower Cladding Layer (I)

The lower cladding layer (I) is formed, for example, on an optical waveguide substrate, using a curable resin composition or a dry film.

Examples of optical waveguide substrates include silicon substrates, quartz substrates, polyimide substrates, PET substrates, liquid crystal polymer substrates, copper foil, copper clad laminates, substrates with circuits formed thereon, etc.

The lower cladding layer (I) may be formed using the photocurable resin composition of the present invention, the photocurable dry film of the present invention, a known composition containing a resin such as a thermosetting resin, active energy ray-curable resin or the like.

Usable thermosetting resins include, for example, combinations of base resins having heat-reactive functional groups, and curing agents having functional groups that are reactive with the heat-reactive functional groups. Also usable are self-crosslinking resins having N-methylol groups, N-alkoxymethylol groups, etc.

Examples of combinations of heat-reactive functional groups and functional groups reactive therewith include carboxy groups and epoxy groups (oxirane groups); carboxylic anhydrides and epoxy groups (oxirane groups); carboxylic anhydrides and oxetane groups; amino groups and epoxy groups (oxirane groups); carboxy groups and hydroxy groups; carboxylic anhydrides and hydroxy groups; blocked isocyanate groups and hydroxy groups; isocyanate groups and amino groups; etc.

Examples of known active energy ray-curable resins include resins containing as essential components compounds each having at least two ring-opening polymerizable functional groups per molecule, optionally in combination with active energy ray polymerization initiators; polymerizable unsaturated compounds, unsaturated resins, etc., optionally in combination with active energy ray polymerization initiators; and the like.

The lower cladding layer (I) can be formed by applying or printing, on an optical waveguide substrate, a known resin composition as mentioned above or the resin composition of the present invention, followed by removing the solvent. After or while removing the solvent, the printed or applied composition can be cured or dried as required, by active energy ray irradiation or heating.

Alternatively, a known resin composition as mentioned above or the resin composition of the present invention may be applied or printed on a base film, followed by removing the solvent, to form a dry film layer on the base film. After peeling off the base film, the dry film can be bonded to an optical waveguide substrate by applying heat and/or pressure to thereby form the lower cladding layer (I). Further alternatively, a laminate comprising a dry film layer formed on a surface of a base film may be bonded to an optical waveguide substrate by applying heat and/or pressure, followed by peeling off the base film, to thereby-form the lower cladding layer (I) on the surface of the optical waveguide substrate.

The lower cladding layer (I) may be cured or dried as required, by active energy ray irradiation, heating or the like.

From the viewpoint of environmental protection, safety, workability, etc., it is especially preferable to form the lower cladding layer (I) by using a dry film.

Further, from the viewpoint of durability, heat resistance, processability, optical transmission properties, etc., it is preferable to form the lower cladding layer (I) by curing the photocurable resin composition or photocurable dry film of the present invention,

Core (II)

The core (II) is formed on part of the surface of the lower cladding layer (I).

The core (II) is preferably formed using the photocurable resin composition or photocurable dry film of the present invention.

To form the core (II) using the photocurable resin composition of the present invention, the composition is applied or printed on the surface of the lower cladding layer (I), and the solvent is removed to form a film of the composition. Subsequently, the film is irradiated with light to form a core pattern, and then developed to remove the unirradiated portion, thereby forming the core (II).

Alternatively, the resin composition may be applied or printed on a base film, followed by removing the solvent, to form a dry film layer on a surface of the base film. After peeling off the base film, the dry film can be bonded on the lower cladding layer (I) by applying heat and/or pressure, thereby forming a film of the composition. Further alternatively, a laminate comprising a dry film layer formed on a surface of a base film may be bonded to the lower cladding layer (I) by applying heat and/or pressure, followed by peeling off the base film, to thereby form a film of the composition on the lower cladding layer (I).

Subsequently, the film of the composition is irradiated with light to form a core pattern, and then developed to remove the unirradiated portion, thereby forming the core (II).

Upper Cladding Layer (III)

The upper cladding layer (III) is formed on the surfaces of the lower cladding layer (I) and core (II), using a curable resin composition or a dry film.

The upper cladding layer (III) may be formed using, for example, the photocurable resin composition of the present invention, the photocurable dry film of the present invention, or a known composition containing a resin such as a thermosetting resin, active energy ray-curable resin or the like.

The upper cladding layer (III) can be formed in the same manner as for forming the lower cladding layer (I).

Specifically, the upper cladding layer (III) can be formed by applying or printing a known resin composition as mentioned above or the resin composition of the present invention on the surfaces of the lower cladding layer (I) and core (II), followed by removing the solvent. After or while removing the solvent, the printed or applied composition can be cured or dried as required, by active energy ray irradiation or heating.

Alternatively, a known resin composition as mentioned above or the resin composition of the present invention may be applied or printed on a base film, followed by removing the solvent, to form a dry film layer on a surface of the base film. After peeling off the base film, the dry film can be bonded to the surfaces of the lower cladding layer (I) and core (II) by applying heat and/or pressure, thereby forming the upper cladding layer (III). Further alternatively, a laminate comprising a dry film layer formed on a surface of a base film may be bonded to the surfaces of the lower cladding layer (I) and core (II) by applying heat and/or pressure, followed by peeling off the base film, to form the upper cladding layer (III).

When necessary, the upper cladding layer (III) may be cured or dried by active energy ray irradiation, heating or the like.

From the viewpoint of environmental protection, safety, workability, etc., it is especially preferable to form the upper cladding layer (III) by using a dry film.

Further, in view of the durability, heat resistance, processability, optical transmission properties, etc., the upper cladding layer (III) is preferably formed by curing the photocurable resin composition of the present invention or the photocurable dry film of the present invention.

The upper cladding layer (III), as a dry film before being bonded to the surfaces of the lower cladding layer (I) and core (II), preferably has a softening temperature within the range of 0° C. to 300° C., and more preferably 15° C. to 200° C. When the dry film has a softening temperature lower than the above, the dry film is softened and becomes sticky when heated for bonding, possibly making bonding operation extremely difficult and/or forming bubbles after bonding. When the dry film has a softening temperature higher than-the above, bonding of the dry film may be difficult.

The dry film for forming the upper cladding layer (III) preferably has a softening temperature lower than that of the core (II), particularly preferably by 10° C. or more.

To form the upper cladding layer (III), the dry film formed on a base film is placed so that the surface of the dry film comes into contact with the surfaces of the core (II) and lower cladding layer (I); and suitable heat and pressure are applied to the surface of the base film at a temperature at least 10° C. higher than the softening temperature of the dry film, by a pressure-bonding method such as atmospheric-pressure hot roll bonding, vacuum hot roll bonding, vacuum hot press bonding, etc. Then, the base film is peeled off from the dry film to transfer the dry film onto the core (II) and lower cladding layer (I), thereby forming an upper cladding layer on the surfaces of the core (II) and lower cladding layer (I).

The upper cladding layer (III) may be cured or dried as required, by active energy ray irradiation, heating or the like.

In the optical waveguide of the present invention, it is preferable that the relative refractive index difference between the core (II) and whichever of the lower cladding layer (I) and upper cladding layer (III) that has the higher refractive index, be at least 0.1%.

As used herein, the relative refractive index difference is defined by the following equation (1).
Relative refractive index difference (%)=[(n₁−n₂)/n₂9 ×100 (1)

wherein n₁ is the refractive index of the core (II); n₂ is the refractive index of whichever of the lower cladding layer (I) and upper cladding layer (III) that has the higher refractive index. These refractive indices are measured using an Abbe refractometer with light having a wavelength of 850 nm.

In order to obtain the above relative refractive index difference, the refractive index of the core (II) needs to be higher than the refractive indices of both the lower cladding layer (I) and upper cladding layer (III).

In the optical waveguide of the present invention, it is usually preferable that, for light having a wavelength of 400 to 1700 nm, the core (II) have a refractive index of 1.420 to 1.650, and that each of the lower cladding layer (I) and upper cladding layer (III) have a refractive index of 1.400 to 1.648. The refractive indices can be adjusted by suitably selecting the resins, additives, proportions thereof, etc.

In the optical waveguide of the present invention, the thicknesses of the lower cladding layer (I), upper cladding layer (III) and core (II) are not limited, and are preferably, for example, each 1 to 200 μm. The width of the core (II) is also not limited, and is preferably, for example, 1 to 200 μm.

Usable active energy rays and light include visible rays, ultraviolet rays, infrared rays, x-rays, α-rays, β-rays, γ-rays, etc. It is preferable to use, for example, a high-pressure mercury lamp, low-pressure mercury lamp, metal halide lamp, excimer lamp or the like, as an irradiation device. There is no limitation on the exposure intensity. It is preferable to perform exposure by irradiation with rays having a wavelength of 200 to 440 nm and an illuminance of 1 to 500 mW/cm² at an exposure intensity of 10 to 5000 mJ/cm².

### EFFECTS OF THE INVENTION

The carboxy-containing unsaturated resin (A) contained in the optical waveguide-forming photocurable resin composition of the present invention can be produced in a simple and easy manner, by reacting the carboxy-containing resin (a) with the epoxy-containing unsaturated compound (b).

Since the resin (A) is produced using a reaction of carboxy groups with epoxy groups, which are highly reactive with each other, the introduction of carboxy groups and unsaturated groups into the resin (A) is ensured.

The resin (A) produced by the reaction has ester bond(s), and films formed using the resin composition of the present invention, which contains the resin (A), has excellent processability, excellent mechanical properties, etc. Accordingly, the resin composition of the present invention is suitable for forming a dry film.

When aromatic ring(s) is introduced into the resin (A), the resin composition of the present invention containing the resin (A) can form a film with a high refractive index.

The use of the photocurable resin composition or photocurable dry film of the present invention makes it possible to form an excellent optical waveguide.

The optical waveguide of the present invention can be advantageously used for connecting optical devices, such as optical integrated circuits, optical modulators, optical switches, optical connectors, optical branching and coupling devices, thin film devices, etc., to optical fibers.

### BEST MODE FOR CARRYING OUT THE INVENTION

The following Production Examples, Examples and Comparative Examples are provided to illustrate the present invention in further detail.

### PRODUCTION EXAMPLE 1

### Production of Photocurable Resin Composition (1)

Methyl methacrylate (40 g), styrene (20 g), butyl acrylate (20 g) and acrylic acid (20 g) were subjected to radical reaction at 110° C. to obtain an acrylic resin (resin acid value: 155 mg KOH/g). Glycidyl methacrylate (24 g), hydroquinone (0.12 g) and tetraethylammonium bromide (0.6 g) were then added to the resin, and a reaction was carried out at 110° C. for 5 hours while introducing air, to thereby obtain a photocurable resin. Subsequently, 100 g (solids) of the photocurable resin, an aminoalkylphenone polymerization initiator (3 g; a product of Ciba Speciality Chemicals; tradename “Irgacure 907”) and ethyl acetate (400 g) were mixed together to obtain photocurable resin composition (1).

### PRODUCTION EXAMPLE 2

### Production of Photocurable Resin Composition (2)

The procedure of Production Example 1 was followed except for using, as acrylic resin monomer components, methyl methacrylate (20 g), styrene (40 g), butyl acrylate (20 g) and acrylic acid (20 g), to thereby obtain photocurable resin composition (2).

### PRODUCTION EXAMPLE 3

### Production of Photocurable Resin Composition (3)

Hydrogenated bisphenol A diglycidyl ether (352 g), acrylic acid (141.2 g), p-methoxyphenol (0.2 g) and triphenylphosphine (1.5 g) were reacted at 95° C. for about 32 hours, and the reaction was terminated when the acid value of the reaction system became 0.5 mg KOH/g or less. Succinic anhydride (70 g) was then added, and a reaction was performed at 90° C. for about 10 hours to obtain a product (photocurable resin) having an acid value of 70 mg KOH/g. Subsequently, 60 g of the product, diacrylate of 5-ethyl-2-(2-hydroxy-1,1-dimethylethyl)-5-(hydroxymethyl)-1,3-dioxane (40 g; a product of Nippon Kayaku Co., Ltd.; tradename “Kayarad R-604”) and 1-hydroxycyclohexylphenylketone (3 g) were mixed together to obtain photocurable resin composition (3).

### PRODUCTION EXAMPLE 4

### Production of Photocurable Dry Film (D-1)

Photocurable resin composition (1) was applied on a polyethylene terephthalate film (film thickness: 25 μm) with a knife edge coater, and dried at 80° C. for 30 minutes to obtain photocurable dry film (D-1).

### PRODUCTION EXAMPLE 5

### Production of Photocurable Dry Film (D-2)

Photocurable resin composition (2) was applied on a polyethylene terephthalate film (film thickness: 25 μm) with a knife edge coater, and dried at 80° C. for 30 minutes to obtain photocurable dry film (D-2).

### PRODUCTION EXAMPLE 6

### Production of Photocurable Dry Film (D-3)

The procedure of Production Example 3 was followed except for using bisphenol A diglycidyl ether in place of hydrogenated bisphenol A diglycidyl ether, to thereby obtain a photocurable resin composition. The composition was applied on a polyethylene terephthalate film (film thickness: 25 μm) with a knife edge coater, and dried at 80° C. for 30 minutes to obtain photocurable dry film (D-3).

### EXAMPLE 1

### Production of Optical Waveguide

(1) Formation of Lower Cladding Layer

Photocurable resin composition (1) was applied on a surface of a silicon substrate by spin coating, and irradiated for 100 seconds with ultraviolet rays having a wavelength of 365 run and an illuminance of 10 mW/cm² to form a lower cladding layer with a thickness of 40 μn.

(2) Formation of Core

Photocurable resin composition (2) was applied on the lower cladding layer by spin coating, and dried at 80° C. for 30 minutes. Subsequently, the applied composition was cured by irradiation for 100 seconds with ultraviolet rays having a wavelength of 365 nm and an illuminance of 10 mW/cm², via a photomask having a pattern consisting of 30 μm-wide lines. The substrate with the ultraviolet ray-irradiated resin composition layer was immersed in a developer made of an aqueous 1.8 wt. % tetramethylammonium hydroxide solution to dissolve the unexposed portion of the resin composition layer, followed by drying. A core having a pattern consisting of 30 μm-wide lines was thus formed.

(3) Formation of Upper Cladding Layer

Photocurable resin composition (1) was applied on the top surfaces of the core and lower cladding layer by spin coating, and irradiated for 100 seconds with ultraviolet rays having a wavelength of 365 nm and an illuminance of 10 mW/cm² to form an upper cladding layer with a thickness of 40 μm.

The obtained optical waveguide were evaluated with respected to transmission loss, core gap, core shape precision, core-covering properties and workability, according to the following criteria. As a result, the transmission loss was rated as A, core gap as A, core shape precision as A, core-covering properties as B, and workability as B.

Transmission loss: Light having a wavelength of 850 nm was input to one end of the optical waveguide, and the amount of light output from the other end was measured to determine the transmission loss per unit length using the cut-back method. A indicates good transmission properties with a loss of not more than 0.4 dB/cm; and B, poor transmission properties with a loss of more than 0.4 dB/cm.

Core gap: A indicates no gap between the projection made by the core and the upper cladding layer; B indicates that there was a gap between the projection made by the core and the upper cladding layer, and, when an organic solvent-based composition was used, shows that popping and bubbling were generated.

Core shape precision: A indicates that the core was not deformed by the upper cladding layer; and B indicates that the core was deformed by the upper cladding layer.

Core-covering properties: A indicates that the thickness of the upper cladding layer at the portion over the projection made by the core was sufficient; B indicates that the thickness of the upper cladding layer at the portion over the projection made by the core was slightly small; and C indicates that the thickness of the upper cladding layer at the portion over the projection made by the core was small.

Workability: A indicates that the entire process for forming the optical waveguide was simple and easy; B indicates that the entire process was slightly complicated; and C indicates that the entire process was complicated and difficult.

Further, the refractive indices of film samples obtained from the resin compositions used for forming the cladding layers and core were measured at 23° C. using a multi-wavelength Abbe refractometer “DR-M4” (a product of Atago Co., Ltd.) with an interference filter having a wavelength of 850 nm. Using the refractive indices obtained, the relative refractive index difference (%) was calculated according to equation (1) shown above. The relative refractive index difference between the core and cladding layers was at least 0.1%.

### EXAMPLE 2

### Production of Optical Waveguide

(1) Formation of Lower Cladding Layer

Photocurable dry film (D-1) was transferred onto a surface of a silicon substrate by atmospheric-pressure hot roll bonding (temperature: 100° C.), and cured by irradiation for 100 seconds with ultraviolet rays having a wavelength of 365 nm and an illuminance of 10 mW/cm². The polyethylene terephthalate film was then peeled off to form a lower cladding layer with a thickness of 40 μm.

(2) Formation of Core

Subsequently, photocurable dry film (D-2) was transferred onto the lower cladding layer by atmospheric-pressure hot roll bonding (temperature: 100° C.)). The transferred dry film was cured by irradiation for 100 seconds with ultraviolet rays having a wavelength of 365 nm and an illuminance of 10 mW/cm², via a photomask having a pattern consisting of 30 μm-wide lines. The polyethylene terephthalate film was then peeled off. The substrate with the ultraviolet ray-irradiated resin composition layer was immersed in a developer made of an aqueous 1.8 wt. % tetramethylammonium hydroxide solution to dissolve the unexposed portion of the resin composition layer, followed by drying. A core having a pattern consisting of 30 μm-wide lines was thus formed.

(3) Formation of Upper Cladding Layer

Photocurable dry film (D-1) was transferred onto the top surfaces of the core and lower cladding layer by atmospheric-pressure hot roll bonding (temperature: 100° C.), and cured by irradiation for 100 seconds with ultraviolet rays having a wavelength of 365 nm and an illuminance of 10 mW/cm². The polyethylene terephthalate film was then peeled off to form an upper cladding layer with a thickness of 40 μm.

The obtained optical waveguide was evaluated according to the above criteria. As a result, the transmission loss was rated as A, core gap as A, core shape precision as A, core-covering properties as A and workability as A. The relative refractive index difference between the core and cladding layers was at least 0.1%.

### COMPARATIVE EXAMPLE 1

### Production of Optical Waveguide

(1) Formation of Lower Cladding Layer

Photocurable resin composition (3) was applied on a surface of a silicon substrate by spin coating, and irradiated for 100 seconds with ultraviolet rays having a wavelength of 365 ni and an illuminance of 10 mW/cm² to form a lower cladding layer with a thickness of 40 μm.

(2) Formation of Core

Subsequently, photocurable dry film (D-3) was transferred onto the lower cladding layer by atmospheric-pressure hot roll bonding (temperature: 100° C.)). The transferred dry film was cured by irradiation for 100 seconds with ultraviolet rays having a wavelength of 365 nm and an illuminance of 10 mW/cm² via a photomask having a pattern consisting of 30 μm-wide lines. The polyethylene terephthalate film was then peeled off. The substrate with the ultraviolet ray-irradiated resin composition layer was immersed in a developer made of an aqueous 1.8 wt. % tetramethylammonium hydroxide solution to dissolve the unexposed portion of the resin composition layer, followed by drying. A core having a pattern consisting of 30 μm-wide lines was thus formed.

(3) Formation of Upper Cladding Layer

Photocurable resin composition (3) was applied on the top surfaces of the core and lower cladding layer by spin coating, and irradiated for 100 seconds with ultraviolet rays having a wavelength of 365 nm and an illuminance of 10 mW/cm to form an upper cladding layer with a thickness of 40 μn.

The obtained optical waveguide was evaluated according to the above criteria. As a result, the transmission loss was rated as A; core gap as B; core shape precision as B; core-covering properties as C; and workability as B.

### PRODUCTION EXAMPLE 7

### Production of Photocurable Resin Composition (4)

Methyl methacrylate (40 g), styrene (20 g), butyl acrylate (20 g) and acrylic acid (20 g) were subjected to radical reaction at 110° C. to obtain an acrylic resin (resin acid value: 155 mg KOH/g). Glycidyl methacrylate (24 g), hydroquinone (0.12 g) and tetraethylammonium bromide (0.6 g) were then added to the resin, and a reaction was carried out at 110° C. for 5 hours while introducing air, to thereby obtain a photocurable resin (the same photocurable resin as obtained in Production Example 1). Subsequently, 124 g (solids) of the photocurable resin, an aminoalkylphenone polymerization initiator (3 g; a product of Ciba Speciality Chemicals; tradename “Irgacure 907”), Epicoat EP-828EL (20 g; a tradename of Japan Epoxy Resin Co., Ltd.) and ethyl acetate (400 g) were mixed together to obtain photocurable resin composition (4).

### PRODUCTION EXAMPLE 8

### Production of Photocurable Resin Composition (5)

Mixed together were 124 g (solids) of the same photocurable resin as obtained in Production Example 2, an aminoalkylphenone polymerization initiator (3 g; a product of Ciba Speciality Chemicals; tradename “Irgacure 907”), Epicoat EP-828EL (20 g; a tradename of Japan Epoxy Resin Co., Ltd.) and ethyl acetate (400 g), to thereby obtain photocurable resin composition (5).

### PRODUCTION EXAMPLE 9

### Production of Photocurable Resin Composition (6)

Mixed together were 124 g (solids) of the same photocurable resin as obtained in Production Example 3, an aminoalkylphenone polymerization initiator (3 g; a product of Ciba Speciality Chemicals; tradename “Irgacure 907”), Epicoat EP-828EL (20 g; a tradename of Japan Epoxy Resin Co.; Ltd.) and ethyl acetate (400 g), to obtain photocurable resin composition (6).

### PRODUCTION EXAMPLE 10

### Production of Photocurable Dry Film (D-4)

Photocurable resin composition (4) was applied on a polyethylene terephthalate film (film thickness: 25 μm) with a knife edge coater, and dried at 80° C. for 30 minutes to obtain photocurable dry film (D-4).

### PRODUCTION EXAMPLE 11

### Production of Photocurable Dry Film (D-5)

Photocurable resin composition (5) was applied on a polyethylene terephthalate film (film thickness: 25 μm) with a knife edge coater, and dried at 80° C. for 30 minutes to obtain photocurable dry film (D-5).

### PRODUCTION EXAMPLE 12

### Production of Photocurable Dry Film (D-6)

The procedure of Production Example 3 was followed except for using bisphenol A diglycidyl ether in place of hydrogenated bisphenol A diglycidyl ether, to obtain a photocurable resin. Mixed together were 124 g (solids) of the obtained photocurable resin, an aminoalkylphenone polymerization initiator (3 g; a product of Ciba Speciality Chemicals; tradename “Irgacure 907”), Epicoat EP-828EL (20 g; a tradename of Japan Epoxy Resin Co., Ltd.) and ethyl acetate (400 g), to obtain a photocurable resin composition. The composition was applied on a polyethylene terephthalate film (film thickness: 25 μm) with a knife edge coater, and dried at 80° C. for 30 minutes to obtain photocurable dry film (D-6).

### EXAMPLE 3

### Production of Optical Waveguide

(1) Formation of Lower Cladding Layer

Photocurable resin composition (4) was applied on a surface of a silicon substrate by spin coating, and irradiated for 100 seconds with ultraviolet rays having a wavelength of 365 nm and an illuminance of 10 mW/cm² to form a lower cladding layer with a thickness of 40 μm. The lower cladding layer was then cured by heating at 150° C. for 60 minutes.

(2) Formation of Core

Photocurable resin composition (5) was applied on the lower cladding layer by spin coating, and dried at 80° C. for 30 minutes. The applied composition was cured by irradiation for 100 seconds with ultraviolet rays having a wavelength of 365 nm and an illuminance of 10 mW/cm², via a photomask having a pattern consisting of 30 μm-wide lines. The substrate with the ultraviolet ray-irradiated resin composition layer was immersed in a developer made of an aqueous 1.8 wt. % tetramethylammonium hydroxide solution to dissolve the unexposed portion of the resin composition layer, followed by drying. A core having a pattern consisting of 30 μm-wide lines was thus formed. The core was then cured by heating at 150° C. for 60 minutes.

(3) Formation of Upper Cladding Layer

Photocurable resin composition (4) was applied on the top surfaces of the core and lower cladding layer by spin coating, and irradiated for 100 seconds with ultraviolet rays having a wavelength of 365 nm and an illuminance of 10 mW/cm² to form an upper cladding layer with a thickness of 40 μm. The upper cladding layer was then cured by heating at 150° C. for 60 minutes.

The obtained optical waveguide was evaluated according to the above criteria. As a result, the transmission loss was rated as A; core gap as A; core shape precision as A; core-covering properties as B; and workability as B.

The relative refractive index difference between the core and cladding layers was at least 0.1%.

### EXAMPLE 4

### Production of Optical Waveguide

(1) Formation of Lower Cladding Layer

Photocurable dry film (D-4) was transferred onto a surface of a silicon substrate by atmospheric-pressure hot roll bonding (temperature: 100° C.), and cured by irradiation for 100 minutes with ultraviolet rays having a wavelength of 365 nm and an illuminance of 10 mW/cm². The polyethylene terephthalate film was then peeled off to form a lower cladding layer with a thickness of 40 μm. The lower cladding layer was then cured by heating at 150° C. for 60 minutes.

(2) Formation of Core

Subsequently, photocurable dry film (D-5) was transferred onto the lower cladding layer by atmospheric-pressure hot roll bonding (temperature: 100° C.). The transferred dry film was cured by irradiation for 100 seconds with ultraviolet rays having a wavelength of 365 nm and an illuminance of 10 mW/cm² via a photomask having a pattern consisting of 30 μm-wide lines. The polyethylene terephthalate film was then peeled off. Thereafter, the substrate with the ultraviolet ray-irradiated resin composition layer was immersed in a developer made of an aqueous 1.8 wt. % tetramethylammonium hydroxide solution to dissolve the unexposed portion of the resin composition layer, followed by drying. A core having a pattern consisting of 30 μm-wide lines was thus formed. The core was then cured by heating at 150° C. for 60 minutes.

(3) Formation of Upper Cladding Layer

Photocurable dry film (D-4) was transferred onto the top surfaces of the core and lower cladding layer by atmospheric-pressure hot roll bonding (temperature: 100° C.), and cured by irradiation for 100 seconds with ultraviolet rays having a wavelength of 365 nm and an illuminance of 10 mW/cm². The polyethylene terephthalate film was then peeled off to form an upper cladding layer with a thickness of 40 μm. Thereafter, the upper cladding layer was cured by heating at 150° C. for 60 minutes.

The obtained optical waveguide was evaluated according to the above criteria. As a result, the transmission loss was rated as A; core gap as A; core shape precision as A; core-covering properties as A; and workability as A.

The relative refractive index difference between the core and cladding layers was at least 0.1%.

### COMPARATIVE EXAMPLE 2

### Production of Optical Waveguide

(1) Formation of Lower Cladding Layer

Photocurable resin composition (6) was applied on a surface of a silicon substrate by spin coating, and irradiated for 100 seconds with ultraviolet rays having a wavelength of 365 nm and an illuminance of 10 mW/cm² to form a lower cladding layer with a thickness of 40 μm. The lower cladding layer was then cured by heating at 150° C. for 60 minutes.

(2) Formation of Core

Subsequently, photocurable dry film (D-6) was transferred onto the lower cladding layer by atmospheric-pressure hot roll bonding (temperature: 100° C.). The transferred dry film was cured by irradiation for 100 seconds with ultraviolet rays having a wavelength of 365 nm and an illuminance of 10 mW/cm², via a photomask having a pattern consisting of 30 μm-wide lines. The polyethylene terephthalate film was then peeled off. The substrate with the ultraviolet ray-irradiated resin composition layer was immersed in a developer made of an aqueous 1.8 wt. % tetramethylammonium hydroxide solution to dissolve the unexposed portion of the resin composition layer, followed by drying. A core having a pattern consisting of 30 μm-wide lines was thus formed. Thereafter, the core was cured by heating at 150° C. for 60 minutes.

(3) Formation of Upper Cladding Layer

Photocurable resin composition (6) was applied on the top surfaces of the core and lower cladding layer by spin coating, and irradiated for 100 seconds with ultraviolet rays having a wavelength of 365 nm and an illuminance of 10 mW/cm² to form a upper cladding layer with a thickness of 40 μm. The upper cladding layer was then cured by heating at 150° C. for 60 minutes.

The obtained optical waveguide was evaluated according to the above criteria. As a result, the transmission loss was rated as A; core gap as B; core shape precision as B; core-covering properties as C; and workability as B.

1. A photocurable resin composition for forming an optical waveguide, the composition comprising a carboxy-containing unsaturated resin (A) obtained by reacting a carboxy-containing resin (a) with an epoxy-containing unsaturated compound (b); a solvent (B); and a biphenol-type epoxy resin or a novolac-type epoxy resin.

2. The photocurable resin composition according to claim 1, further comprising a radical photopolymerization initiator.

3. A photocurable dry film for forming an optical waveguide, which is formed using the photocurable resin composition according to claim 1.

4. An optical waveguide comprising a lower cladding layer (I), a core (II) and an upper cladding layer (III), wherein at least one of (I), (II) and (III) is formed using the photocurable resin composition according to claim 1.

5. An optical waveguide comprising a lower cladding layer (I), a core (II) and an upper cladding layer (III), wherein at least one of (I), (II) and (III) is formed using the photocurable dry film according to claim 3.
